(19) United States
(12) Patent Application Publication
(10) Pub. No.: US 2011/0206473 A1
(43) Pub. Date: Aug. 25, 2011

(54) METHOD FOR MANUFACTURING LOW DISTORTION CARBURIZED GEARS

(75) Inventors: Travis M. Thompson, Ann Arbor, MI (US); Stephen D. Doubler, Rochester Hills, MI (US); Jeffrey R. Lee, Tipton, MI (US)

(73) Assignee: GM GLOBAL TECHNOLOGY OPERATIONS LLC, Detroit, MI (US)

(21) Appl. No.: 13/100,794

(22) Filed: May 4, 2011

Related U.S. Application Data
(62) Division of application No. 11/556,770, filed on Nov. 6, 2006.

(51) Int. Cl. B23F 17/00

(52) U.S. Cl. 409/6

(57) ABSTRACT

A system and method for manufacturing an internal gear is provided. A carrier is used to transport a gear blank having a first predefined pitch diameter to face width ratio. A forming tool is used for forming a plurality of teeth on the gear blank and provides other gear and spline forming operations. A furnace heats the gear having the plurality of teeth formed thereon to a predefined temperature for a predefined length of time to form a carburized gear. Finally, a cutting tool is provided to cut the gear at predefined location along its face to form at least two separate gears each having a second and third pitch diameter to face width ratios.

### CROSS-REFERENCE TO RELATED APPLICATIONS

This application claims the benefit of U.S. patent application Ser. No. 11/556,770 filed on Nov. 6, 2006. The disclosure of the above application is incorporated herein by reference.

### TECHNICAL FIELD

The invention relates to a method for manufacturing ferrous gears to minimize distortion of the gears during heat treatment, especially, in gears having a high pitch diameter to face width ratio.

### BACKGROUND

In the manufacturing of gears it is desirable, if not necessary, to heat-treat the gears after the gear formation process. Heat treatment increases the hardness characteristics of the gear and, thus, increases the useful life of the gear. One method of heat treatment is carburization/quench/temper. Carburizing involves dissolving carbon in the surface layers of a low-carbon steel part at a temperature typically between 850 and 1010° C. (1560 and 1850° F.), sufficient to render the steel austenitic, followed by quenching and tempering to form a martensitic microstructure. Hardening is achieved by quenching the high-carbon surface layer to form martensite. The resulting part has a high-carbon martensitic case with good wear and fatigue resistance superimposed on a tough, low-carbon steel core.

Carburizing processes include Gas and Low pressure (vacuum) carburizing followed by media quenches. Gas carburizing is carried out in a substantially closed furnace where the parts are surrounded by a continuous (i.e. gaseous hydrocarbons, vaporized hydrocarbon liquids) carbon-bearing atmosphere that is continuously replenished so that a high carbon potential can be maintained. Quenching is typically preformed in oil. Low pressure Carburizing is carried out in a substantially closed furnace utilizing an oxygen free environment with a carbon-bearing single component (i.e. propane, acetylene) non-continuous atmosphere. Quenching is preformed in oil or inert gas media. Tempering after quench is utilized in either carburizing method and involves re-heating the gear between 150 and 700° C. (300 and 1300° F.) to achieve a desirable (non-brittle) tempered martensitic microstructure. Carburizing (with associated quench and temper) as a heat treatment method for internal gears is desirable because it produces a high strength gear at a relatively low cost.

However, at present, some internal gears are not able to be carburized due to the amount of dimensional distortion (particularly, roundness and twist) imparted by heat treatment. These gears typically have a high pitch diameter to face width ratio. As a result, these gears are made from alternate materials and heat treat methods. Some internal gears are made from high carbon alloy steel and induction hardened, others from core treated material and nitrided. Both of these options have higher manufacturing costs (higher material cost and higher machining cost) and have lower levels of strength compared to a carburized gear.

The conventional manufacturing process starts with: first, receiving a pre-machined blank; second, performing green machining (gear & spline cutting operations); and, finally, heat treatment (after which the gear is considered a finished part). Optionally, a shot peen or shot blast operation may follow the heat treatment step. It would be desirable to provide a low cost gear manufacturing process for producing gears of various configurations having a high pitch diameter to face width ratio. Moreover, the gears should have minimal to no manufacturing defects attributable to the heat treatment process.

### SUMMARY

A system for manufacturing an internal gear is provided. The system includes a carrier, a forming tool, a furnace and a cutting tool. The carrier is used to transport a gear blank having a first predefined pitch diameter to face width ratio. The forming tool is for forming a plurality of teeth on the gear blank and provides other gear and spline forming operations. The furnace heats the gear having the plurality of teeth formed thereon to a predefined temperature for a predefined length of time to form a carburized gear. The cutting tool is provided to cut the gear at predefined location along its face to form at least two separate gears each having a second and third pitch diameter to face width ratios.

In another aspect of the present invention, gear blank has a first pitch diameter to face width ratio that is less than each of the second and third pitch diameter to face width ratios.

In still another aspect of the present invention, the plurality of teeth is formed on an interior surface of the gear blank to form an internal gear.

In still another aspect of the present invention, the furnace heats the gear to a temperature above 1560° F.

In still another aspect of the present invention, the furnace heats the gear blank to the predefined temperature and holds the gear at the predefined temperature long enough to obtain a carburized surface of suitable carbon content and depth

In yet another aspect of the present invention, heating the gear further includes subjecting the gear to a carburizing process.

In yet another aspect of the present invention cutting the gear at predefined location along the gear face further includes cutting the gear in half to form two separate gears having equal gear face widths.

In yet another aspect of the present invention cutting the gear at predefined location along the gear face further includes cutting the gear to form two separate gears having unequal gear face widths.

In yet another aspect of the present invention, a method for manufacturing an internal gear is provided. The method includes selecting a gear blank having a first predefined pitch diameter to face width ratio, forming a plurality of teeth on the gear blank, placing the gear having a plurality of teeth formed thereon into a furnace, heating the gear having a plurality of teeth formed thereon in the furnace to a predefined temperature for a predefined length of time to form a heat treated gear with hardened surfaces, and cutting the gear at predefined location along the face of the gear to form at least two separate gears each having a second and third pitch diameter to face width ratio.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1a is a perspective view of a gear manufactured using the system and method of the present invention;

FIG. 1b is a perspective view of a gear blank used to produce the gear of FIG. 1a, in accordance with the present invention;

FIG. 2 is a schematic representation of a system for manufacturing the gear of FIG. 1a, in accordance with an embodiment of the present invention;

FIG. 3 is a flowchart illustrating the method for manufacturing the gear of FIG. 1b, in accordance with the present invention; and

FIG. 4 is a perspective view a pair of gears manufactured using the process of FIG. 2 and the gear blank shown in FIG. 1b, in accordance with the present invention.

### DESCRIPTION OF THE PREFERRED EMBODIMENTS

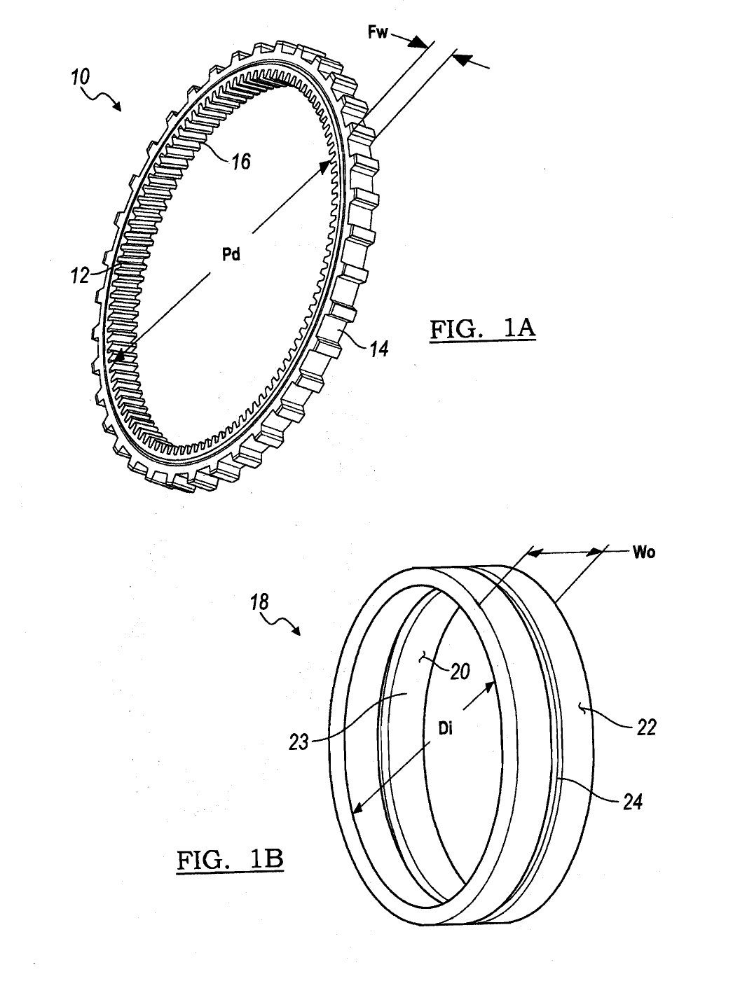

Referring to the drawings, wherein like reference numbers refer to like components, in FIG. 1a an internal gear 10 is depicted. The gear 10 is generally cylindrical in shape and has an inner gear face 12 and an outer gear face 14. Generally, gear 10 has a plurality of gear teeth 16 formed on inner gear face 12. Gear teeth or other features specific to the particular application of gear 10 may also be formed on outer gear face 14. Outer gear face 14 has a face width referenced in FIG. 1a as Fw. Face width Fw is the dimensional width of the outer gear face 14 of gear 10. Further, gear 10 has a pitch diameter referenced in FIG. 1a as Pd. The pitch diameter Pd is the inside diameter of gear 10. The pitch diameter to face width ratio is a very important physical relationship to consider in determining that appropriate manufacturing process to utilize to produce gear 10. Those skilled in the art will appreciate that gears having a variety of face widths and pitch diameters may be manufactured using the teachings of the present invention including but not limited to internal and external gears.

FIG. 1b is a perspective view of a preformed gear blank 18. Gear blank 18 is the raw material that is used to form internal gear 10. Gear blank 18 has a smooth inner face or surface 20 on which the plurality of teeth 16 are formed and a smooth outer face or surface 22 on which features may be formed. Alternatively, gear blank 18 may have a smooth outer or inner surface 20, 22 having a single annular groove 23, 24 (shown in FIG. 1b) in one or both surfaces or multiple annular grooves in inner or outer surfaces 20, 22 (not shown). The gear blank having an annular groove in the outer surface 22 is referred to as a compound gear blank, because cutting the gear along the annular gear produces multiple gears. The gear blank will have an inside diameter Di and an outer face width Wo. Preferably, the Di/Wo ratio defines a gear having a relatively low pitch diameter to face width ratio. As will be described and illustrated hereinafter, gears having a relatively high pitch diameter to face width ratio will be formed from gear blank 18 having a low Di/Wo ratio.

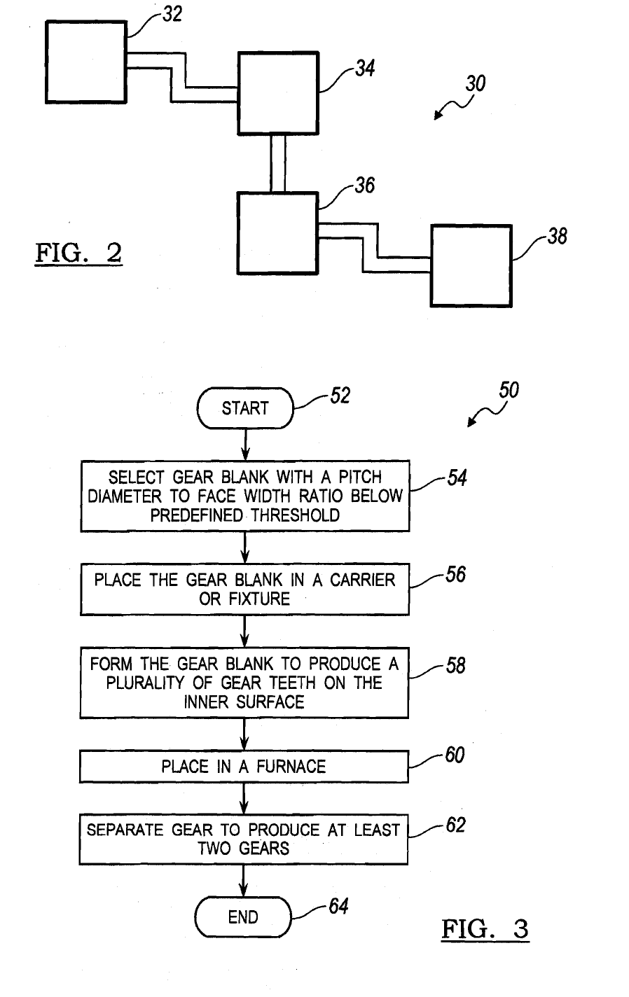

Referring now to FIG. 2, a system 30 for manufacturing gear 10 is illustrated, in accordance with an embodiment of the present invention. System 30 includes a carrier 32, a forming tool 34, a heat treat furnace 36 and a cutting tool 38. The carrier 32 is, for example, a tray, a fixture, a conveyor or a robot configured to pick up and move gear 18 or any combination of these devices. The purpose of carrier 32 is to transport the raw material (i.e. a gear blank) through the manufacturing system 30. The forming tool 34 is metal shaping or gear cutting machine having a metal cutting tool. Those skilled in the art will appreciate forming tool 34 may be a single machine with a plurality of cutting blades or devices or several machines having a single or plurality of cutting blades or devices. The primary purpose of forming tool 34 is to form a plurality of teeth on the inner face 20 of gear blank 18 or perform other gear and spline cutting operations.

Heat treat furnace 36 is preferably an industrial furnace capable of receiving a single gear or a large volume of gears. Further, the inside of heat treat furnace 36 is configured to reach temperatures in excess of 1700° F. The primary purpose of heat treat furnace 36 is to heat the formed gear having the plurality of teeth to a predefined temperature for a predefined length of time to form a heat-treated or carburized gear. Carburizing involves dissolving carbon in the surface layers of a low-carbon steel part at a temperature typically between 850 and 1010° C. (1560 and 1850° F.), sufficient to render the steel austenitic, followed by quenching and tempering to form a martensitic microstructure. Hardening is achieved by quenching the high-carbon surface layer to form martensite. The resulting part has a high-carbon martensitic case with good wear and fatigue resistance superimposed on a tough, low-carbon steel core.

The present invention contemplates the use of Gas and Low pressure (vacuum) carburizing followed by media quenches. Gas carburizing is carried out in a substantially closed furnace where the parts are surrounded by a continuous (i.e. gaseous hydrocarbons, vaporized hydrocarbon liquids) carbon-bearing atmosphere that is continuously replenished so that a high carbon potential can be maintained. Quenching is typically preformed in oil. Low pressure Carburizing is carried out in a substantially closed furnace utilizing an oxygen free environment with a carbon-bearing single component (i.e. propane, acetylene) non-continuous atmosphere. Quenching may also be preformed in an inert gas media which achieves a different cooling rate than oil and results in slightly different microstructure. Tempering after quench is utilized in either carburizing method and involves re-heating the gear between 150 and 700° C. (300 and 1300° F.) to achieve a desirable (non-brittle) tempered martensitic microstructure. Carburizing (with associated quench and temper) as a heat treatment method for internal gears is desirable because it produces a high strength gear at a relatively low cost.

The cutting tool 38 is a device or machine that has a single or a plurality of metal cutting blades. For example the cutting tool 38 is a lathe operation. Those skilled in the art will appreciate that cutting tool 38 may be a separate machine or device from forming tool 34 or the same device as forming tool 34. The primary purpose of cutting tool 38 is to cut the carburized gear at predefined location along its face to form at least two separate gears each having a second and third pitch diameter to face width ratios.

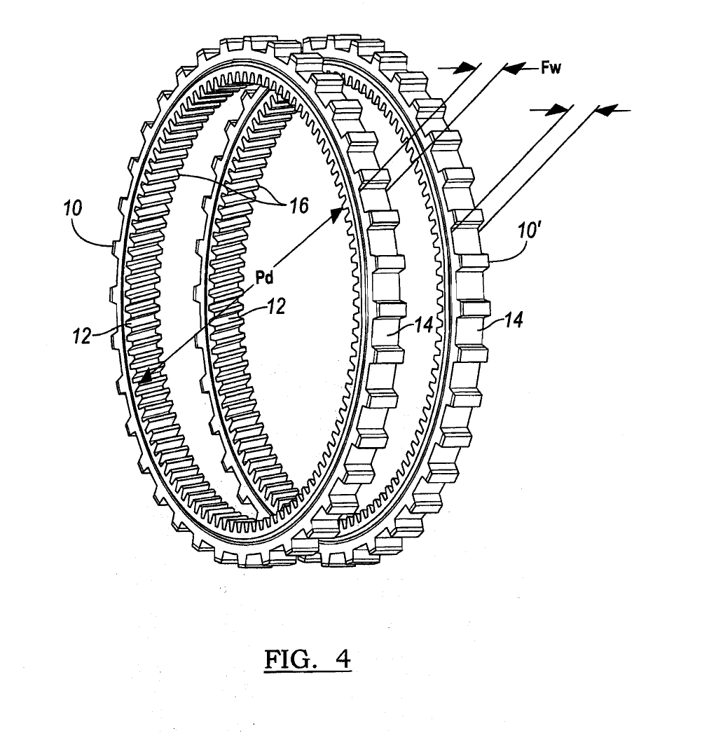

Referring now to FIG. 3, a flowchart illustrating a method 50 for manufacturing the internal gear of FIG. 1a using system 30 illustrated in FIG. 2 is shown, in accordance with an embodiment of the present invention. The process is initiated at block 52. At block 54, a gear blank (i.e. gear blank 18) is selected having a pitch diameter to face width ratio that is below a predefined ratio threshold. The ratio threshold is defined as the pitch diameter to face width ratio that produces a gear having minimal dimensional distortions after being treated by a heat treat process such as carburizing process or similar process. Further, at block 56, the gear blank is placed in a carrier or fixture for transporting the gear blank to the next step in the manufacturing process. At block 58, the gear blank is machined using a metal forming machine to produce a plurality of gear teeth of a specified configuration either on the inner or outer surfaces of the gear. Further, additional features may be formed on the inner or outer gear surfaces as required for the particular gear application. The formed gear having a plurality of gear teeth and other features formed in the surfaces of the gear is exposed to a carburizing process or heat treatment process. For example, the formed gear is placed in a furnace, as represented by block 60. The carburizing process is the process described in U.S. Pat. No. 4,152,177 or any similar process that is capable of producing a gear or metal workpiece having hardened surfaces. After the carburizing process is complete the heat treated gear is removed form the furnace and placed in a fixture or holder for transportation to the next manufacturing station. At block 62, the heat treated gear (formed from the gear blank 18 of FIG. 1b) is placed in a cutting device or machine having a cutting blade or blades for cutting the treated gear into at least two separate gears 10, 10′, as shown in FIG. 4. More specifically, at block 62 the heat treated gear is cut along its outer gear face at a location along the gear face to produce at least two separate gears each having a predefined gear face width and, thus, pitch diameter to gear face width ratio. Of course, the present invention contemplates cutting the treated gear at multiple locations along the gear face to produce multiple gears having either the same or different pitch diameter to gear face width ratios. Alternatively, if the treated gear has annular grooves disposed in the outer face of the gear then the gear is cut along the annular grooves to separate the gears into two or more gears. The process is complete, as represented by block 64.

By this process the present invention produces gears that are virtually free of dimensional distortions. The present invention achieves gears that are substantially distortion free by selecting a gear blank that has a pitch diameter to face width ratio that is below a predefined threshold. More specifically, the predefined threshold is the maximum pitch diameter to face width ratio that produces a gear that is substantially free of dimensional distortions and specifically distortions such as roundness and twist caused by heat treatment or carburization. The present invention contemplates the use of other heat treatment processes and gears and gear blanks made of steel, steel alloys and other suitable metals.

While the best modes for carrying out the invention have been described in detail, those familiar with the art to which this invention relates will recognize various alternative designs and embodiments for practicing the invention within the scope of the appended claims.

What is claimed is:

1. A system for manufacturing a gear, the system comprising:
a carrier for transporting a gear blank having an inner gear face, an outer gear face and a first pitch diameter to face width ratio;
a forming tool for forming a plurality of teeth on at least one of the inner gear face and outer gear face of the gear blank;
a heat treat furnace for heat treating the gear blank by heating the gear blank to a predefined temperature for a predefined length of time; and
a cutting tool for cutting the heat treated gear blank at a predefined location along the outer face of the gear to form at least a first gear and a second gear wherein the first gear has a second pitch diameter to face width ratio and the second gear has a third pitch diameter to face width ratio.

2. The system of claim 1, wherein the first pitch diameter to face width ratio is less than each of the second and third pitch diameter to face width ratios.

3. The system of claim 1, wherein the plurality of teeth are formed on the inner face of the gear blank to form an internal gear.

4. The system of claim 1, wherein the heat treat furnace heats the gear blank to a temperature from about 850° C. to about 1010° C.

5. The system of claim 1, wherein the heat treat furnace is configured to provide a carburizing atmosphere for subjecting the gear blank to a carburizing process.

6. The system of claim 1, wherein heat treating the gear blank results in a carburized surface of the gear blank having a predefined carbon content and depth.

7. The system of claim 1, wherein the first and second gears have equal gear face widths.

8. The system of claim 1, wherein the first and second gears have unequal gear face widths.

9. The system of claim 1, wherein the outer face of the gear blank has an annular groove disposed at the predefined location.

10. The system of claim 1 further including a quenching mechanism and a tempering furnace.

11. The system of claim 10 wherein the quenching mechanism utilizes an oil or inert gas media.

12. The system of claim 10 wherein the tempering furnace is capable of re-heating the gear blank from about 150° C. to about 700° C.

13. A system for manufacturing a gear, the system comprising:
a carrier for transporting a gear blank having an inner gear face, an outer gear face and a first pitch diameter to face width ratio;
a forming tool for forming a plurality of teeth on at least one of the inner gear face and outer gear face of the gear blank;
a heat treat furnace for heat treating the gear blank by heating the gear blank to a predefined temperature for a predefined length of time;
a quenching mechanism for quenching the gear blank in at least one of an oil and an inert gas media;
a tempering furnace for tempering the gear blank by re-heating the gear blank to a temperature from about 150° C. to about 700° C.; and
a cutting tool for cutting the heat treated, quenched and tempered gear blank in an annular groove at a predefined location along the outer face of the gear to form at least a first gear and a second gear wherein the first gear has a second pitch diameter to face width ratio and the second gear has a third pitch diameter to face width ratio.

14. The system of claim 13, wherein the first pitch diameter to face width ratio is less than each of the second and third pitch diameter to face width ratios.

15. The system of claim 13, wherein the plurality of teeth are formed on the inner face of the gear blank to form an internal gear.

16. The system of claim 13, wherein the heat treat furnace heats the gear blank to temperature from about 850° C. to about 1010° C.

17. The system of claim 13, wherein the heat treat furnace is configured to provide a carburizing atmosphere for subjecting the gear blank to a carburizing process.

18. The system of claim 13, wherein heat treating the gear blank results in a carburized surface of the gear blank having a predefined carbon content and depth.

19. The system of claim 13, wherein the first and second gears have equal gear face widths.

20. The system of claim 13, wherein the first and second gears have unequal gear face widths.
